(19) United States
(12) Patent Application Publication
(10) Pub. No.: US 2013/0227565 A1
(43) Pub. Date: Aug. 29, 2013

(54) APPARATUS AND METHOD FOR MANAGING APPLICATION FOR GUEST OPERATING SYSTEM

(71) Applicant: PANTECH CO., LTD., (US)

(72) Inventors: Chang-Ju LEE, Goyang-si (KR); Chan-Hee PARK, Suwon-si (KR); Seok-Ho CHOI, Seoul (KR)

(73) Assignee: PANTECH CO., LTD., Seoul (KR)

(21) Appl. No.: 13/674,538

(22) Filed: Nov. 12, 2012

(30) Foreign Application Priority Data
Feb. 24, 2012 (KR) 10-2012-0019292

(51) Int. Cl. G06F 9/455

(52) U.S. Cl. 718/1

(57) ABSTRACT

An apparatus includes a processor to operate a host OS, a host application managing unit to receive a request for managing a guest application operable in the guest OS, the request including application information of the guest application, and a guest application managing unit under the operation of the host OS to receive the request from the host application managing unit and to manage the guest application according to the request. A method includes operating a host operating system (OS), receiving a request for managing an application under the operation of the host OS, determining whether the application is operable in a guest OS, and transmitting application information of the application and the request to a guest application managing unit that is operable via a virtual machine monitor in response to the determination that the application is operable in the guest OS.

### CROSS-REFERENCE TO RELATED APPLICATION

This application claims priority from and the benefit under 35 U.S.C. §119(a) of Korean Patent Application No. 10-2012-0019292, filed on Feb. 24, 2012, which is incorporated by reference for all purposes as if fully set forth herein.

### BACKGROUND

1. Field

The following description relates to an application management method for a mobile terminal, and more particularly, to an apparatus and a method for managing an application for a guest operating system.

2. Discussion of the Background

With the development of information and communication technologies, types of electronic apparatuses have become diversified. A cellular phone, an MP3 player, a digital camera, a portable multimedia player (PMP), a navigation supporting device (Global Positioning Systems for location tracking), a portable game console, an electronic dictionary, an E-book reader, and a digital multimedia broadcasting (DMB) receiver have emerged and evolved. Further, tablet computers, such as a smart phone and a smart pad, have been adopted rapidly by electronic device users.

A smart mobile terminal, such as a smart phone or tablet computer, is mounted with a mobile operating system (OS). Hardware performance of the mobile terminals has been rapidly improved as well as mobile OSs to support multitasking and background processing.

Meanwhile, virtualization technology refers to a technology that generates one or a plurality of logical virtual machines (VMs) on a virtualization layer. Virtualization technology may be classified into two types according to the method for forming the virtualization layer. One type uses a method for forming a virtualization layer on a host OS while the other type uses a method for installing a virtual machine monitor (VMM) or a hypervisor that directly provides a virtualization layer onto a host OS. According to the virtualization technology, guest OSs may be installed on a plurality of virtual machines (VMs), respectively, and applications supported on the corresponding guest OSs may be installed on the respective guest OSs.

The guest OS that operates in the virtualization layer can be an OS of a different type from the host OS. A ‘terminal for supporting different types of guest OSs’ (hereinafter, referred to as a ‘virtualization terminal’) indicates a terminal in which one or more different types of guest OSs are installed on the host OS by using virtualization technology. For example, a mobile terminal, in which the host OS is Android and the guest OS is iOS or Windows mobile, may correspond to the virtualization terminal. In the virtualization terminal, the guest OS may operate on the host OS.

The terminal mounted with the OS can perform application management, such as downloading, installing, and launching an application on the OS. In the virtualization terminal, an application that operates only in the host OS or the guest OS can be installed and launched. For example, only an Android application can be installed and launched in an Android host OS, and only an iOS application can be installed and launched in an iOS guest OS. Further, the guest OS needs to be driven first in order to download, install, and launch an application that operates in the guest OS in the virtualization terminal. Therefore, if the guest OS is not driven while the host OS is driven, downloading, installing, or launching of an application operable on the guest OS may not be manageable.

The above information disclosed in this Background section is only for enhancement of understanding of the background of the invention and therefore it may contain information that does not form any part of the prior art nor what the prior art may suggest to a person of ordinary skill in the art.

### SUMMARY

The following description relates to a mobile terminal and method for managing an application compatible with a guest OS. In a virtualization terminal, a user may download and install an application for a guest OS via a host OS. According to an aspect, an application management platform for downloading, installing, and launching an application of a guest OS in a mobile terminal supporting a different type of guest operating system may be provided. The download and installation of an application for the guest OS may be performed without driving the guest OS.

Further, an application installed in a guest OS may be launched with information on the application via a host OS.

The download and installation of an application for the guest OS may be performed without driving the guest OS.

Exemplary embodiments of the present invention provide an apparatus to manage an application for a guest operating system (OS), including a processor to operate a host OS; a host application managing unit to receive a request for managing a guest application operable in the guest OS, the request including application information of the guest application; and a guest application managing unit under the operation of the host OS to receive the request from the host application managing unit and to manage the guest application according to the request.

Exemplary embodiments of the present invention provide a method that uses a processor to manage an application for a guest operating system (OS), including: operating a host OS; receiving a request for managing an application under the operation of the host OS;

determining, using the processor, whether the application is operable in the guest OS; and transmitting application information of the application and the request to a guest application managing unit that is operable via a virtual machine monitor in response to the determination that the application is operable in the guest OS.

Exemplary embodiments of the present invention provide an apparatus to manage an application for a guest operating system (OS), including a processor to operate a host OS; an application selection interface to display a guest application icon during the operation of the host OS, the guest application icon including a link to launch a guest application operable in the guest OS; a host application managing unit to transmit a request for launching the guest application in response to a selection of the guest application icon, the request including application information of the guest application; and a guest application managing unit to receive the request for launching the guest application from the host application managing unit and to launch the guest application according to the request.

It is to be understood that both forgoing general descriptions and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a diagram illustrating a system architecture having a host OS and a guest OS according to an exemplary embodiment of the present invention.

FIG. 2 is a diagram illustrating communication between a host application managing unit and a guest application managing unit according to an exemplary embodiment of the present invention.

FIG. 3 is a flowchart illustrating a method for downloading an application for a guest OS according to an exemplary embodiment of the present invention.

FIG. 4 is a flowchart illustrating a method for transferring an application from a host OS to a guest OS according to an exemplary embodiment of the present invention.

FIG. 5 is a flowchart illustrating a method for installing an application based on an OS type according to an exemplary embodiment of the present invention.

FIG. 6 is a flowchart illustrating a method for launching an application based on an OS type according to an exemplary embodiment of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the embodiments set forth herein. Rather, these exemplary embodiments are provided so that this disclosure is thorough, and will fully convey the scope of the invention to those skilled in the art. It will be understood that for the purposes of this disclosure, “at least one of X, Y, and Z” can be construed as X only, Y only, Z only, or any combination of two or more items X, Y, and Z (e.g., XYZ, XZ, XYY, YZ, ZZ). Throughout the drawings and the detailed description, unless otherwise described, the same drawing reference numerals are understood to refer to the same elements, features, and structures. The relative size and depiction of these elements may be exaggerated for clarity.

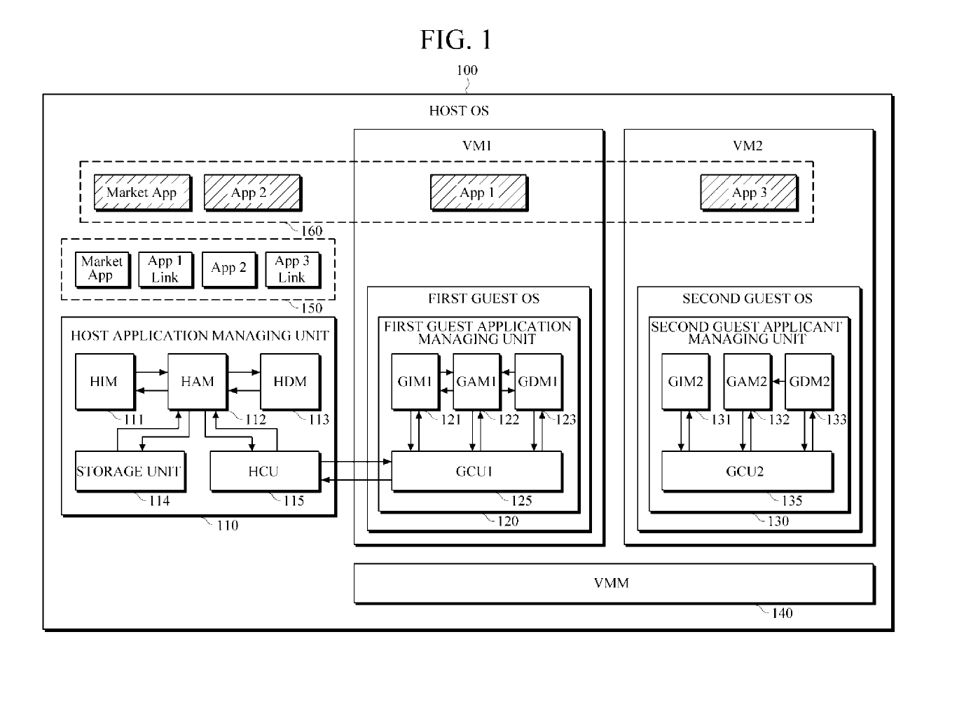

FIG. 1 is a diagram illustrating a system architecture having a host OS and a guest OS according to an exemplary embodiment of the present invention. A mobile terminal supporting different types of virtualizations refers to a mobile terminal that may generate one or more virtual machines VM1 and VM2 on a host OS. One or more guest operation systems (OSs) may be mounted on a virtual machine monitor (VMM). For example, at least one guest OS (first guest OS1 and second guest OS2) of different type from the host OS may be mounted on the virtual machines VM1 and VM2 as shown in FIG. 1. FIG. 1 illustrates two virtual machines VM1 and VM2 generated on a virtual machine monitor (VMM) 140 on the host OS of an application management apparatus, e.g., a mobile terminal. The VMM may be mounted on the host OS as shown in FIG. 1, but is not limited as such. VMM may be mounted on hardware and multiple OSs may be mounted on the VMM. The guest OS may be a different type from the host OS. The first guest OS that is mounted on the first virtual machine VM1 may be different from the host OS and the type of the OS mounted on the second virtual machine VM2 may be identical to the host OS or the first guest OS, for example.

As shown in FIG. 1, the application management apparatus may include an application selection interface 150 and driving applications 160 that may be launched in the respective OSs. For example, Application 1 (“App 1”), App 2, and App 3 may be executable in the first guest OS, the host OS, and the second guest OS, respectively. The application selection interface 150 may include a user interface (UI). A user may select a market App, and App 2 from the host OS by selecting a corresponding execution file that may be implemented as an icon. Further, the UI may provide a link for executing App 1 and App 3 via the first and second guest OS, respectively, and the user may launch App 1 or App 3 from the host OS operation state.

Referring to FIG. 1, the application management apparatus 100 includes a host application managing unit 110 installed to operate on a host OS in an application management apparatus 100, and guest application managing units 120 and 130 installed to operate on one or more guest OSs (first guest OS and second guest OS). The host application managing unit 110 downloads and installs an application on the host OS and launches the installed application. The host application managing unit 110 may perform a communication with guest application managing units 120 and 130 and perform management operations to download, install, and launch an application on a guest OS. The guest application managing units 120 and 130 may download and install an application on the guest OS, perform communication with the host application managing unit 110 to download, install, and/or launch the guest application while the host OS operates, and launch the installed application.

The host application managing unit 110 may include a host install manager (HIM) 111, a host application manager (HAM) 112, a host download manager (HDM) 113, a storage unit 114, and a host communication unit (HCU) 115. The guest application managing unit 120 may include a guest install manager 1 (GIM1) 121, a guest application manager 1 (GAM1) 122, a guest download manager 1 (GDM1) 123, and a guest communication unit 1 (GCU1) 125. The guest application managing unit 130 may include a guest install manager 2 (GIM2) 131, a guest application manager 2 (GAM2) 132, a guest download manager 2 (GDM2) 133, and a guest communication unit 2 (GCU2) 135.

Hereinafter, the first guest application managing unit 120 that operates on the first guest OS that may be a different type from the host OS will be described. Description regarding the first guest managing unit 120 may be applied to the second guest managing unit 130. If the second guest OS on which the second guest application managing unit 130 operates is an OS of the same type as the host OS, the description with respect to the first guest OS may be applied except the difference of the OS type, and if the second guest OS is a different type from the host OS, it is appreciated that the description regarding the first guest application managing unit 120 to be described below may be similarly applied to the second guest application managing unit 130.

The HIM 111 and the GIM1 121 serve to install an application on the host OS and the first guest OS, respectively. The HIM 111 installs an application of a type that operates on the host OS, and the GIM1 121 installs an application of a type that operates on the first guest OS. The application installed by the HIM 111 or GIM1 121 may be downloaded from the application market or app store, but may be an application transferred through an e-mail, a messenger, and the like, or an application copied through other storage media. Requests for installing applications by launching the HIM 111 and the GIM1 121 may be transferred from the HAM 112 or the GAM1 122 to the HIM1 111 or the GIM1 121, respectively. Further, a request for installing an application by launching the GIM1 may be input from a user through the host OS and transferred to the GIM1 121 through the HCU 115 and the GCU1 125. In this case, the application installation request to the GIM1 121 may be transferred directly from the GCU1 125 to the GIM1 121 or from the GCU1 125 to the GIM 121 through the GAM1 122.

The HAM 112 and the GAM1 122 may perform management operations, such as installing, downloading, and launching of an application on the host OS and the first guest OS, respectively. For example, the HAM 112 may request downloading an application to the HDM 113 or installing an application to the HIM 111, and receive a downloading result from the HDM 113 or installing result from the HIM 111. The GAM 122 may request downloading an application to the GDM1 123 or installing an application to the GIM1 121, and receive a downloading result from the GDM1 123 or installing result from the GIM1 121.

If the HAM 112 and/or the GAM1 122 receive a launching request for an application from the user, the HAM 112 and the GAM1 122 may launch the requested application. The HAM 112 and the GAM1 122 may display information on the applications installed in the host OS and the first guest OS through the user interface (UI). The HAM 112 may display the information on the application installed in the host OS through the UI and display information on the application installed in the first guest OS and other guest OS through the UI. For example, the application selection interface 150 represents that both the application information (Market App and App2) installed in the host OS and the application information (App1 Link and App3 Link) installed in the guest OSs are displayed through the UI. The user may recognize the information on the application installed in the guest OS while operating the host OS, and may select and launch the applications installed on the guest OSs.

The HAM 112 and the GAM1 122 may store information for launching an application, e.g., an application-launching information profile. The application-launching information profile may include an OS type compatible with the corresponding application may be launched, and information for launching each application.

The HAM 112 and the GAM1 122 may generate a request including information to be communicated between the host application managing unit 110 and the first guest application managing unit 120. For example, the HAM 112 may generate a request for downloading, installing, or launching the application on the first guest OS, and transfer the request to the first guest application managing unit 120 through the HCU 115 and the GCU1 125. The GAM1 122 may transfer result information regarding the received request, e.g., result information that an application is downloaded, installed, or launched on the first guest OS, to the host application managing unit 110 through the GCU1 125 and the HCU 125.

The HAM 112 may identify the compatible OS type of an application to be downloaded, installed, and launched. If it is determined that the OS type of the application to be downloaded, installed, and launched is the host OS, the HAM 112 may transfer the request to the HIM 111 or the HDM 113, which installs or downloads the application or directly launch the requested application. If it is determined that the OS type of the application to be downloaded, installed, and launched is the first guest OS, the HAM 112 may transfer the request to the guest application managing unit 120 through the HCU 115 and the GCU1 125 to allow the guest application managing unit 120 to download, install, and launch the corresponding application.

The HAM 112 may identify the OS type of an application by using information included in application information (ApplicationInfo) received from the application market or the app store when downloading the application. The application information (ApplicationInfo) received from the market may include an application name (procesName), permission (Permission), file name (filename), extension (fileExt), size (Size), OS type (OSType), and an application address for launching or downloading (“Uniform Resource Identifier; uri”). The HAM 112 may determine the OS type of the application by using the OS type information or the extension information.

The HAM 112 may determine the OS type of the application by using the extension of a file. If an application file to be installed is stored in a mobile terminal after receiving through an e-mail, messenger, or from other storage media, the application information (ApplicationInfo) may not be included in the stored file. If the application information is not included the OS type of the application may be determined from the extension information of the application execution file. For example, if the OS is Android, the extension is ‘apk’. If the OS is iOS, the extension is ‘ipa’. If the OS is Windows, the extension is ‘exe’. Since the extension depends on and corresponds to the OS, the HAM 112 may identify the OS type by using the extension of the downloaded file.

The HDM 113 and the GDM1 123 may serve to download an application onto the host OS and the first guest OS, respectively. The HDM 113 downloads the application of the type that operates on the host OS, and the GDM1 123 downloads the application of the type that operates on the first guest OS. The HDM 113 and the GDM1 123 may launch a market application or an app store application installed in the host OS and the first guest OS, respectively, to download an application by accessing a market server or an app store server. A request for downloading applications by launching the HDM 113 or the GDM1 123 may be transferred from the HAM 112 or the GAM1 122 to the HDM 113 or the GDM1 123, respectively.

Further, an application providing server or an application selling server that may be accessed by launching and accessing the market application installed in the host OS is a server that provides applications capable of operating on at least one of various types of OSs. If the user launches the market application on the host OS, the user may download both the OS that operates on the host OS and the OS that operates on the guest OS. Both the HDM 113 and the GDM1 123 may download an application that may operate on the corresponding OS through the same application providing server or application selling server. A request for downloading the application by launching the GDM1 123 may be input from the user through the host OS and transferred to the GDM1 123 through the HCU 115 and the GCU1 125. The application downloading request to the GDM1 123 may be transferred directly from the GCU1 125 to the GDM1 123, or from the GCU1 125 to the GDM1 123 through the GAM1 122.

The storage unit 114 may store information for the HAM 112 to manage the application installed in the host OS and information to manage the application installed in the first guest OS or installed in the second guest OS. For example, the storage unit 114 may store both the application information (ApplicationInfo) received when downloading the application, and information used to install or launch the corresponding application. The storage unit 114 may store both the information for installing the application in the first guest OS and information (e.g., application link information) to launch the application installed in the first guest OS. A downloading result, an installing result, and a launching result of the application in the first guest OS may be stored in the storage unit 114.

The HCU 115 and the GCU1 125 are modules for performing communication between the host application managing unit 110 and the first guest application managing unit 120. The HCU 115 and the GCU1 125 transfer various requests (e.g., a downloading request, an installing request, and a launching request) between the application managing units 110 and 120, and transfer responses (a downloading result, an installing result, and a launching result) in response to the requests. The HCU 115 and the GCU1 125 may be implemented by using inter processor communication (IPC).

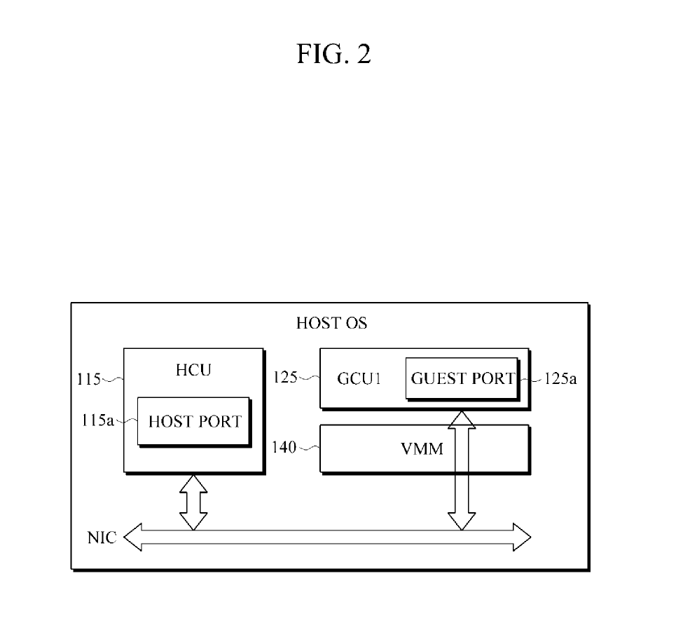

FIG. 2 is a diagram illustrating an example for implementing communication between an HCU and a GCU1 according to an exemplary embodiment of the present invention. In FIG. 2, an NIC indicates a network interface card. FIG. 2 may be an example of implementing communication between the HCU 115 and the GCU1 125 by using socket communication as an example of the IPC, and in FIG. 2, a request or information from the HCU 115 to the GCU1 125 may be transferred through the following process.

First, the HCU 115 that receives the request or information to be transferred to the GCU1 125 verifies whether the first guest OS that transfers the request to the virtual machine monitor VMM 140 operates. If the first guest OS does not operate, the HCU 115 may perform a procedure for stopping a host port 115a and operating the first guest OS. For this operation, the HCU 115 may acquire a list of OSs installed in each virtual machine (VM) through the virtual machine monitor 140. The HCU 115 may compare the name of an acquired OS and the name of an OS that is to be launched to determine whether a supporting OS exists. If the OS to be operated exits in the list, the HCU 115 transfers the name of the OS to be launched to the virtual machine monitor 140. The virtual machine monitor 140 launches the OS installed in the corresponding virtual machine (VM) by driving the virtual machine (VM) capable of driving the OS corresponding to the name of the received OS.

The HCU 115 may operate the host port 115a to initiate a communication. The host port 115a listens to a socket for connecting to a guest port 125a. The guest OS is booted according to a command from the virtual machine monitor 140, and the guest port 125a is also launched during this process. If the guest port 125a is launched, the guest port 125a may generate a socket to connect to the host port 115a. The guest port 125a may request the connection to the host port 115a and wait for a response. If the host port 115a receives the connection request in the socket, the host port 115a sets up the connection and notifies the connection set-up to the HCU 115.

If socket connection is achieved between the host port 115a and the guest port 125a through the aforementioned process, the HCU 115 may transfer the received request or information to the guest port 125a through the host port 115a. The GCU1 125 that receives the request or information through the guest port 125a may determine which module of the guest application managing unit 120 (see FIG. 1) the request or information will be transferred to by parsing a received packet, and may transfer the request or information to the corresponding module. Further, the GCU1 125 may just transfer the received request or information to the GAM1 122, and the GAM1 122 may transfer the request or information to the final destination according to the content of the received packet.

Next, the application management method will be described with reference to the diagram of the host OS shown in FIG. 1. The application management method may be applied to a procedure of managing an application installed on the guest OS (hereinafter, referred to as a ‘guest application’) as well as an application installed on the host OS (hereinafter, referred to as a ‘host application’) while operating the host OS and a procedure of managing the host application as well as the guest application while operating the guest OS.

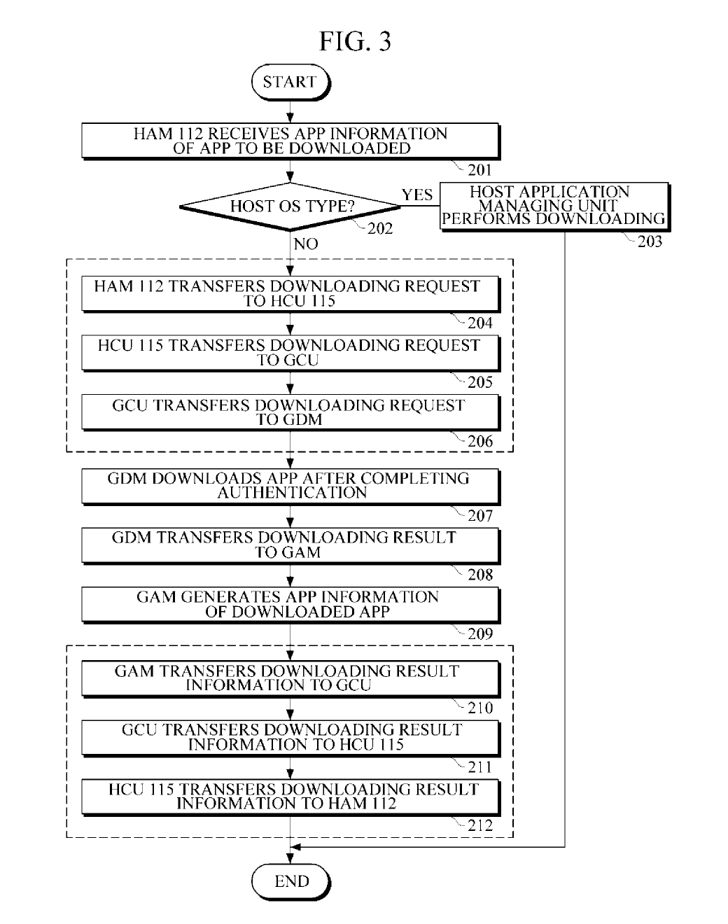

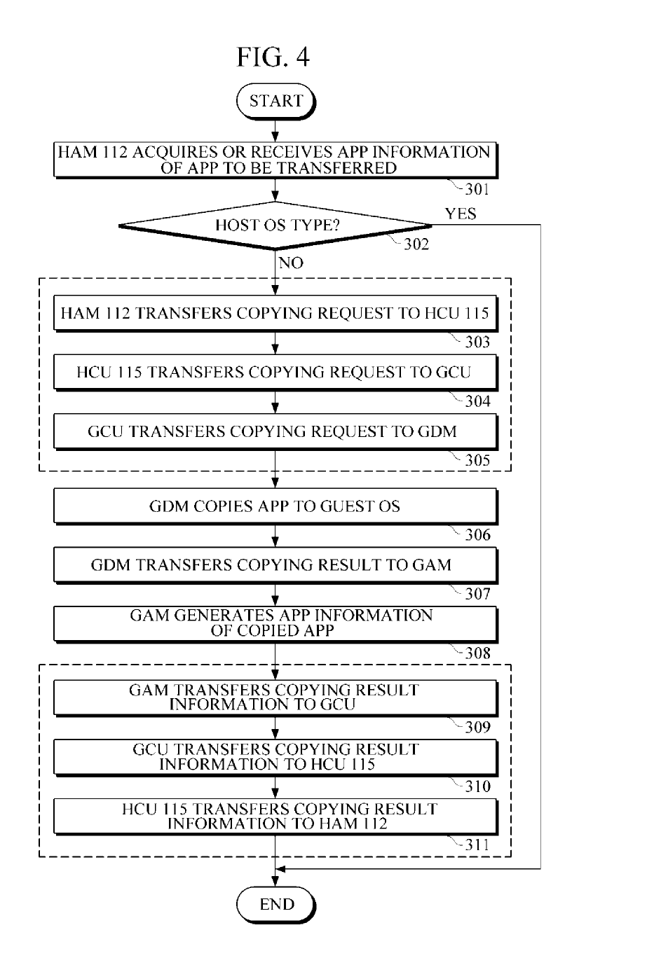

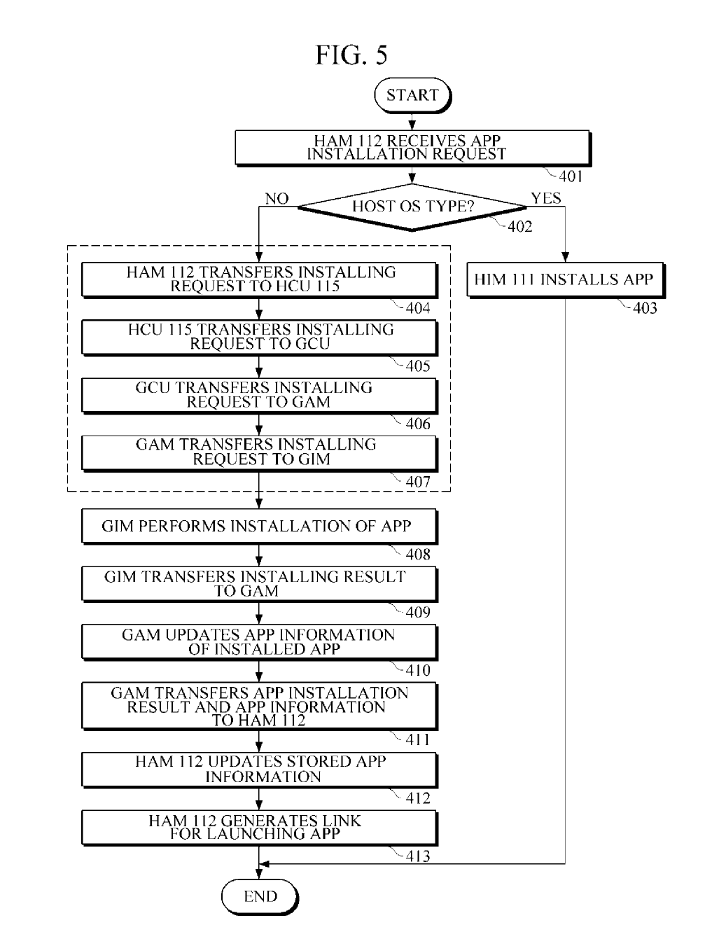

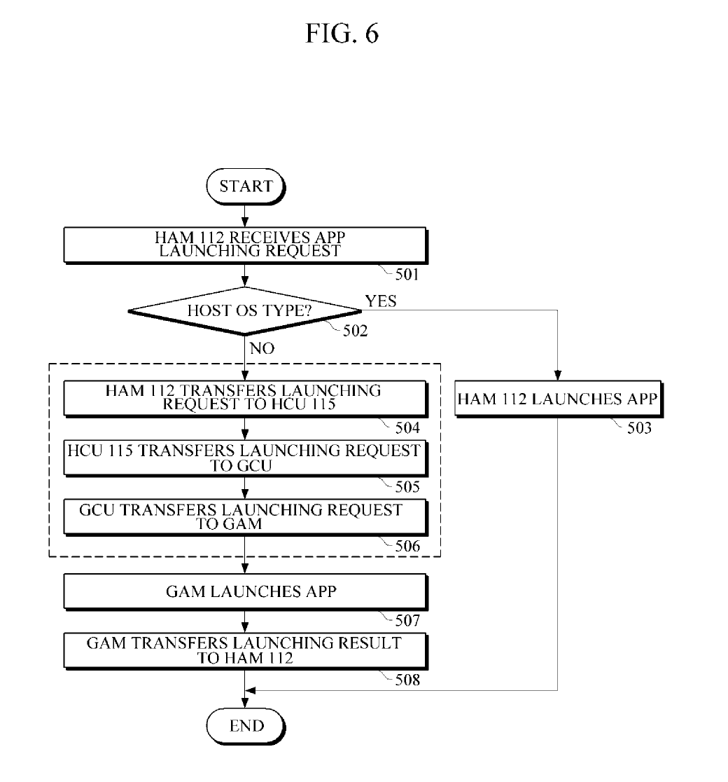

FIG. 3 is a flowchart illustrating a method for downloading an application for a guest OS according to an exemplary embodiment of the present invention. An application market or app store may provide not only the application that operates on any one OS (e.g., host OS) but also the application that operates on another type of OS (e.g., first guest OS). FIG. 3, FIG. 4, FIG. 5, and FIG. 6 will be described as if performed by the application management apparatus 100 shown in FIG. 1, but is not limited as such.

Referring to FIG. 1 and FIG. 3, the HAM 112 receives application information of an application to be downloaded in operation 201. The application to be downloaded may be selected by a user. For example, the user may access the application market by launching a market application (Market App) displayed on the application selection interface 150 and may select the application to be downloaded by selecting one among applications provided in the application market. If the application to be downloaded is selected, application information (ApplicationInfo) of the corresponding application provided from the application market may be transferred to the HAM 115.

The HAM 112 determines whether the corresponding application is a host application or a guest application in operation 202. The host application refers to an application that operates on the host OS, and the guest application refers to an application that operates on a guest OS. The HAM 112 may determine the OS type of the corresponding application by using the application information (ApplicationInfo) received in operation 201. The OS type information (OSType) or extension information (fileExt) included in the application information may be used to determine the OS type.

If the selected application is the host application, the host application managing unit 110 may download the corresponding application in operation 203. For example, if the HAM 112 transfers the downloading request including the application address information (uri) to the HDM 113, the HDM 113 may download the corresponding application by using the application address information (uri).

If it is determined that the selected application is not the host application but the guest application, the host application managing unit 110 transfers the downloading request to the guest application managing unit 120 in operations 204, 205, and 206. The downloading request may include an authentication token for the application market in conjunction with the application information (ApplicationInfo). The application information may include information for identifying the application which the guest application managing unit 120 will download, and the authentication token may include authentication information for the guest application managing unit 120 to access the application market.

In more detail, the HAM 112 transfers the application information and/or the downloading request including the authentication token to the HCU 115 in operation 204. The HCU 115 transfers the application information and the downloading request including the authentication token to the GCU (GCU1 125 or GCU2 135) in operation 205, and the GCU transfers the received downloading request to the GDM (GDM1 123 or GDM2 133) in conjunction with the additional information in operation 206. The GCU may not transfer the downloading request directly to the GDM but may transfer the downloading request to the GDM through the GAM (GAM1 122 or GAM2 132).

The GDM downloads the corresponding application after completing an authentication process with the application market in operation 207. The authentication process between the GDM and the application market may be performed by using the authentication token included in the downloading request. The GDM may download the application through the application address information (uri) that may be included in the additional information included in the application download request.

The GDM transfers downloading result information to the GAM in operation 208. The downloading result information may include whether downloading is successful and/or address information (e.g., application route information on the guest OS) of the downloaded application if the downloading is successful. In operation 209, the GAM generates new application information for the downloaded application by using the received downloaded information and the application information (ApplicationInfo) received during the operation 205.

The guest application managing unit 120 transfers the downloading result information to the host application managing unit 110 in operations 210, 211, and 212. The downloading result information may include the application information (ApplicationInfo) generated during the operation 209 and information of whether the downloading is successful. The GAM transfers the downloading result information including the downloading result and/or the application information to the GCU in operation 210. The GCU transfers the downloading result information including the downloading result and/or the application information to the HCU 115 in operation 211, and the HCU 115 transfers the received downloading result information to the HAM 112 in conjunction with the application information in operation 212. Although not shown in the figure, the application information received during the operation 212 may be stored in the storage unit 214.

FIG. 4 is a flowchart illustrating a method for transferring a guest application from a host OS to a guest OS according to an exemplary embodiment of the present invention. The guest application received while the host OS operates may be a guest application that is downloaded or copied onto the storage unit 114 while operating the host OS through e-mail, messenger, or other storage media. The guest application may be a guest application that is downloaded onto the storage unit 114 while operating the host OS through the application market.

Referring to FIG. 1 and FIG. 4, the HAM 112 acquires or generates application information of a received application to be transferred to a guest OS in operation 301. If the application information exists in conjunction with the application, the HAM 112 may acquire the application information from the application. If the application information is not provided in conjunction with the application that is downloaded or copied while operating the host OS, the HAM 112 may generate the application information. The generated application information may include at least the OS type information (OSType) and the application route information. For example, the application information may include a process name, permission, a file name, a file extension, a file size, a compatible OS type, a URI, and the like.

The HAM 112 determines whether the corresponding application is the host application or the guest application in operation 302. The HAM 112 may determine the type of the corresponding application by using the application information (ApplicationInfo) that is acquired or generated during the operation 301. The OS type information (OSType) or extension information (fileExt) of the corresponding application, which is included in the application information, may be determined.

If it is determined that the selected application is the host application, the application is not transferred to the guest OS. If it is determined that the selected application is the guest application, the host application managing unit 110 transfers the downloading request to the guest application managing unit 120 in operations 303, 304, and 305. The downloading request may include the application information (ApplicationInfo) including the application route information on the host OS storing the selected application. The application route information may include information for the guest application managing unit 120 to receive the corresponding application.

The HAM 112 transfers the downloading request including the application route information to the HCU 115 in operation 303. The HCU 115 transfers the downloading request including the application information and/or the application route information to the GCU in operation 304, and the GCU transfers the received downloading request to the GDM in conjunction with the additional information in operation 305. Further, the GCU may not transfer the downloading request directly to the GDM but may transfer the downloading request to the GDM through the GAM.

The GDM transfers the corresponding application to the guest OS by using the application route information included in the downloading request in operation 306. The GDM transfers the downloading result information to the GAM in operation 307. The downloading result information may include information of whether the transfer is successful and/or address information (e.g., the application route information on the guest OS) of the transferred application. The GAM generates new application information for the transferred application by using the application information (ApplicationInfo) received during the operation 304 as well as the received downloading result information in operation 308.

The guest application managing unit 120 transfers the downloading result information to the host application managing unit 110 in operations 309, 310, and 311. The downloading result information may include the application information (ApplicationInfo) generated during the operation 308 and information of whether downloading is successful. The GAM transfers the downloading result information including the transfer result and/or the application information to the GCU in operation 309. The GCU transfers the downloading result information including the transfer result and/or the application information to the HCU 115 in operation 310, and the HCU 115 transfers the received downloading result information to the HAM 112 in conjunction with the application information in operation 311. Although not shown in the figure, the application information received during the operation 311 may be stored in the storage unit 114.

FIG. 5 is a flowchart illustrating a method for installing an application based on an OS type according to an exemplary embodiment of the present invention. Applications downloaded in association with the host OS and applications downloaded in association with the guest OS may be installed while operating the host OS.

Referring to FIG. 1 and FIG. 5, an application installation request is transferred to the HAM 112 in operation 401. An application to be installed may be selected by a user while operating the host OS. Since information on the application downloaded in association with the guest OS is transferred to the host OS to be managed by the HAM 112, the user may know the application information downloaded in association with the guest OS. The application information may be used in the installation process while operating the host OS.

The HAM 112 determines whether the application requested to be installed is the host application or the guest application in operation 402. The HAM 112 may determine the type of the corresponding application by using the application information (ApplicationInfo) stored in the storage unit 114. For example, the OS type information (OSType) or extension information (fileExt) included in the application information may be used for the determination.

If it is determined that the selected application is the host application, the host application managing unit 110 installs the corresponding application to be executed by the host OS in operation 403. For example, if the HAM 112 transfers application installation information including the application address information (uri) to the HIM 111 in conjunction with the installation request, the HIM 111 may perform the installation process of the corresponding application by using the application address information (uri).

If it is determined that the selected application is the guest application, the host application managing unit 110 transfers the installation request to the guest application managing unit 120 in operations 404, 405, 406, and 407. The application information (ApplicationInfo) including the application route information or the application address information may be transferred to the guest application managing unit 120 in conjunction with the installation request. The application route information is information for the guest application managing unit 120 to identify and install the application to be installed.

The HAM 112 transfers the installation request including the application information to the HCU 115 in operation 404, and the HCU 115 transfers the installation request including the application information to the GCU in operation 405. The GCU transfers the received installation request to the GAM in conjunction with the additional information in operation 406, and the GAM transfers the installation request to the GIM. The GCU may not transfer the installation request to the GAM but may transfer the installation request directly to the GIM.

The GIM performs the installation process of the corresponding application in operation 408. The GIM installs an application stored in a storage that may be accessed via a route by using the application route information included in the installation request. The application route information is information indicating the location at which the corresponding application file is stored. If the application file is downloaded in association with the guest OS as described above with reference to FIG.3 and FIG. 4, the application route information may indicate a storing location in association with the guest OS. If the application file is downloaded in association with the host OS, the application route information may indicate a storing location in association with the host OS.

The GIM transfers installation result information to the GAM in operation 409. The installation result information may include information of whether the installation process is successful and/or address information (e.g., the application route information on the guest OS) of the installed application. The GAM updates the application information on the application installed by using the application information (ApplicationInfo) received during the operation 406 and the received installation result information in operation 410.

The guest application managing unit 120 transfers the installation result information to the host application managing unit 110 in operation 411. The GAMtransfers the installation result information to the HAM 122 through the GCU and the HCU 115. The installation result information includes the application information (ApplicationInfo) updated during the operation 410 and information of whether the installing is successful. The HAM 122 updates the application information of the corresponding application stored in the storage unit 114 by using the received installation result information in operation 412.

The HAM 122 generates a link to launch the corresponding application by using the updated application information in operation 413. As shown in application selection interface 150 of FIG. 1, an icon of the host application installed in association with the host OS and an icon of the guest application installed in association with the guest OS may be displayed in a UI while operating the host OS. The link generated in the operation 413 may be used for the display of the icons. The HAM 122 may generate a guest application launching link icon and display the generated icon on a display by using information, such as application name, guest OS type, and the like, in the updated application information. The route information where the corresponding guest application is installed and a launching request message to request launching the route information to the GAM are included in the guest application launching link.

FIG. 6 is a flowchart illustrating a method for launching an application based on an OS type according to an exemplary embodiment of the present invention. The applications installed in association with the host OS and applications installed in association with the guest OS may be the corresponding applications described in FIG. 5, but are not limited as such. The application installed in association with the host OS and the application installed in association with the guest OS may be launched while operating the host OS.

Referring to FIG. 1 and FIG. 6, an application launching request is transferred to the HAM 112 in operation 501. An application to be launched may be selected by a user while operating the host OS. Since information on the application installed in association with the guest OS is transferred to the host OS to be managed by the HAM 112 and the application installed in association with the guest OS is displayed on the application selection interface 150, the user may know the application information installed in association with the guest OS while operating the host OS.

The HAM 112 determines whether the application requested to be launched is the host application or the guest application in operation 502. The HAM 112 may determine the type of the corresponding application by using the application information (ApplicationInfo) stored in the storage unit 114. For example, the OS type information (OSType) or extension information (fileExt) included in the application information may be used for the determination. If the selected application is the host application, the HAM 112 of the host application managing unit 110 launches the corresponding application in operation 503.

If it is determined that the selected application is a guest application, the host application managing unit 110 transfers the launching request to the guest application managing unit 120 in operations 504,505, and 506. The application information (ApplicationInfo) including the application route information or the application address information is transferred to the guest application managing unit 120 in conjunction with the launching request. The application route information is information for the guest application managing unit 120 to identify and launch the application. The HAM 112 transfers the launching request including the application information to the HCU 115 in operation 504, and the HCU 115 transfers the launching request including the application information to the GCU in operation 505. The GCU transfers the received launching request to the GAM in conjunction with the additional information in operation 506.

The GAM performs the launching process of the corresponding application in operation 507. The GAM may launch the application stored in the corresponding route by using the application route information included in the launching request. The guest application managing unit 120 transfers launching result information to the host application managing unit 110 in operation 508. The GAM may transfer the launching result information to the HAM 122 through the GCU and the HCU 115. Information indicating whether launching is successful may be included in the launching result information. The HAM 122 may update the application information of the corresponding application stored in the storage unit 114 by using the received launching result information.

The exemplary embodiments of the present invention may be implemented as computer-readable codes in a computer-readable recording medium. The computer-readable recording medium includes all types of record media in which computer readable data is stored. Examples of computer readable record medium include a ROM, a RAM, a CD-ROM, a magnetic tape, a floppy disk, and optical data storage. Computer-readable recording medium may be distributed to computer systems over a network, in which computer readable codes may be stored and executed in a distributed manner.

According to exemplary embodiments of the present invention, if a request for downloading, installing, and launching an application is received from a user, it may be determined whether the corresponding application is a host application or a guest application and a host OS performs the request for downloading, installing, and launching the application, or a guest OS performs the request for downloading, installing, and launching the application via the host OS according to the type of the application. If a result of downloading, installing, and launching performed by the guest OS is transferred to the host OS, the host application managing unit of the host OS stores information on a guest application. Based on information on the guest application, the user may initiate a process of downloading, installing, and/or launching the guest application while operating the host OS without driving the guest OS.

It will be apparent to those of ordinary skill in the art that various modifications can be made to the exemplary embodiments of the invention described above. However, as long as modifications fall within the scope of the appended claims and their equivalents, they should not be misconstrued as a departure from the scope of the invention itself

What is claimed is:

1. An apparatus to manage an application for a guest operating system (OS), comprising:
a processor to operate a host OS;
a host application managing unit to receive a request for managing a guest application operable in the guest OS, the request comprising application information of the guest application; and
a guest application managing unit under the operation of the host OS to receive the request from the host application managing unit and to manage the guest application according to the request.

2. The apparatus of claim 1, further comprising: a storage device to store the guest application and the application information of the guest application.

3. The apparatus of claim 1, wherein the application information of the guest application comprises at least one of OS type information of the guest application, and a uniform resource identifier (URI).

4. The apparatus of claim 1, further comprising: a virtual machine to operate the guest OS to launch the guest application, and
wherein the request for managing a guest application comprises a request for launching the guest application, and the guest application managing unit launches the guest application in response to the request for launching the guest application using the virtual machine.

5. The apparatus of claim 1, wherein the guest application managing unit receives an authentication token from the host application managing unit, and requests authentication using the authentication token to download the guest application.

6. The apparatus of claim 1, wherein the guest application managing unit downloads the guest application via a uniform resource identifier (URI) included in the application information of the guest application.

7. The apparatus of claim 1, wherein the host application managing unit determines whether the guest application is compatible with the guest OS based on a file extension of the guest application or the application information including OS type information.

8. The apparatus of claim 1, wherein the guest application managing unit generates updated application information of the guest application in response to a downloading or installing completion of the guest application, and transmits the updated application information to the host application managing unit.

9. The apparatus of claim 8, wherein the host application managing unit generates a link for executing the guest application, and stores the updated application information in a storage device.

10. The apparatus of claim 9, wherein the host application managing unit transmits a request for launching the guest application comprising the updated application information to the guest application managing unit.

11. A method that uses a processor to manage an application for a guest operating system (OS), comprising:
operating a host OS;
receiving a request for managing an application under the operation of the host OS;
determining, using the processor, whether the application is operable in the guest OS; and
transmitting application information of the application and the request to a guest application managing unit that is operable via a virtual machine monitor in response to the determination that the application is operable in the guest OS.

12. The method of claim 11, wherein the application information of the application comprises at least one of OS type information of the guest application, and a uniform resource identifier (URI).

13. The method of claim 11, further comprising: operating the guest OS using a virtual machine to launch the application in response to the request; and
launching the application in association with the guest OS.

14. The method of claim 11, further comprising:
receiving an authentication token if the request corresponds to a download request; and
requesting authentication using the authentication token to download the application.

15. The method of claim 11, further comprising: downloading the application via a uniform resource identifier (URI) included in the application information of the application.

16. The method of claim 11, wherein the determining of whether the application is operable in the guest OS is performed based on a file extension of the application or the application information including OS type information.

17. The method of claim 11, further comprising:
generating updated application information of the application in response to a downloading or installing completion of the application.

18. The method of claim 17, further comprising:
generating a link for executing the guest application; and
storing the updated application information.

19. The terminal of claim 18, further comprising: transmitting a request for launching the application comprising the updated application information to the guest application managing unit.

20. An apparatus to manage an application for a guest operating system (OS), comprising:
a processor to operate a host OS;
an application selection interface to display a guest application icon during the operation of the host OS, the guest application icon comprising a link to launch a guest application operable in the guest OS;
a host application managing unit to transmit a request for launching the guest application in response to a selection of the guest application icon, the request comprising application information of the guest application; and
a guest application managing unit to receive the request for launching the guest application from the host application managing unit and to launch the guest application according to the request.
